(19) United States
(12) Patent Application Publication
(10) Pub. No.: US 2008/0052364 A1
(43) Pub. Date: Feb. 28, 2008

(54) SYSTEM AND METHOD FOR PROTECTING E-MAIL SENDER IDENTITY VIA USE OF CUSTOMIZED RECIPIENT E-MAIL ADDRESSES

(76) Inventor: Xiang Zhou, Irvine, CA (US)

Correspondence Address: XIANG ZHOU, 129 CONFEDERATION WAY, IRVINE, CA, 92602, US

(21) Appl. No.: 11/837,496

(22) Filed: Aug. 11, 2007

Related U.S. Application Data
(60) Provisional application No. 60/823,145, filed on Aug. 22, 2006.

(51) Int. Cl. G06F 15/16

(52) U.S. Cl. 709/206

(57) ABSTRACT

A system and method are disclosed for protecting e-mail sender identity by redirecting e-mail messages to an e-mail forwarding server via use of customized recipient e-mail addresses. An e-mail message is sent from a user's actual e-mail account to a customized recipient e-mail address. Because an e-mail forwarding server of the present invention is the Mail Exchange (MX) authority for the domain of the customized recipient e-mail address, the e-mail message is sent to the e-mail forwarding server. The e-mail forwarding server contains a database that stores users' actual e-mail addresses and their associated alias e-mail addresses. When the message is received by the e-mail forwarding server, it parses the message recipient's e-mail address to obtain the intended recipient's e-mail address, replaces the message sender's actual e-mail address with its associated alias e-mail address, and delivers the message to the original intended recipient. To the recipient the message appears to be sent directly from the sender's alias e-mail address. Therefore the sender's actual e-mail identity is not exposed to the recipient. When the e-mail forwarding server receives an e-mail message sent or replied to the user's alias e-mail address, it automatically forwards the message to the user's actual e-mail address.

### CROSS-REFERENCE TO RELATED APPLICATIONS

This application claims the benefit of provisional patent application Ser. No. 60/823,145, filed Aug. 22, 2006 by the present inventor.

### FEDERALLY SPONSORED RESEARCH

Not Applicable

### SEQUENCE LISTING OR PROGRAM

Not Applicable

### BACKGROUND

1. Field of the Invention

The present invention relates to a system and method for protecting e-mail sender identity, and more specifically to a system and method utilizing customized recipient e-mail addresses to redirect e-mail messages to an e-mail forwarding server to protect sender's actual e-mail address and other identifying information from being exposed on a communications network.

2. Prior Art

E-mail is an essential communications tool for business and individuals. However exposing actual e-mail identity on the Internet is becoming a problem because actual e-mail identity may contain personal information, such as senders' e-mail addresses, company or organization names, network usernames, and Internet Service Provider (ISP) names. E-mail address itself could also be sensitive personal information since it may associate with online banking or e-commerce user IDs. As incidences of online identity theft have steadily climbed in recent years, there is always a risk that someone could glean enough personal information to usurp people's identity. Therefore the actual e-mail identity should be protected just like other personal identifying information, only being given out to trusted parties.

Spam is another reason why actual e-mail identity should NOT be exposed on the Internet. For most Internet users getting spam messages each and every day is a fact of life. Even with various state and federal laws and spam filtering software, this barrage seems to be never ending. One of the best strategies to avoid spam is to keep the actual e-mail addresses private and not let spammers know they even exist. But this is a difficult task to accomplish. Every time Internet users give their actual e-mail addresses to an online vendor, send a message to a mailing list, or join a web forum, they are exposing their actual e-mail addresses. Therefore protecting the actual e-mail addresses is easier said than done.

One approach to solving half of this problem is using e-mail forwarding services. Current e-mail forwarding services are able to forward e-mail messages received from one e-mail address to anther e-mail address. Therefore users' actual e-mail accounts can receive e-mail messages which are sent to the e-mail addresses of the e-mail forwarding service. It helps to keep actual e-mail addresses private. But this method only works for receiving e-mail messages. It cannot protect the actual e-mail addresses from being exposed on the Internet if they want to send e-mail messages directly from their actual e-mail accounts.

Another approach to protecting the actual e-mail addresses from identity theft and spam is using separate e-mail accounts. For example, two e-mail accounts can be created: One for friends and family only, and another for others. If the e-mail address for others starts getting spammed, it can be just abandoned, without having to create a new e-mail address for friends and family again. However this method is inconvenient for those who need to switch back and forth between different e-mail addresses frequently. Usually it requires users to enter their user names and passwords to log on different e-mail accounts if they want to send e-mail messages with a different e-mail address.

Yet another approach to sending or receiving e-mail messages with a different e-mail address is using “Send As” feature in some e-mail systems. The “Send As” feature allows a user to send e-mail messages as if from another e-mail address or e-mail account. But the “Send As” feature has many limitations: First not every e-mail system provides the “Send As” feature and e-mail users have no choice if their e-mail system doesn't offer this feature. Second the “Send As” feature may require a system administrator to setup a separate e-mail address and grant proper permissions for a user to use it. Third it may also require e-mail users to use some specific e-mail client software or devices (e.g., Microsoft Outlook) and many mobile devices or e-mail client software either do not support the “Send As” feature or can not easily switch back and forth between different e-mail addresses or e-mail accounts. Fourth the “Send As” feature could possibly cause the sender's actual e-mail address, e-mail domain name, and computer IP address being revealed. Because some e-mail systems store sender's actual e-mail address and computer IP address in the message headers or use the same e-mail servers delivering both e-mail messages. Fifth the “Send As” feature could also cause e-mail messages being marked as spam if the messages are sent from the e-mail systems which are not legitimate mail sources for the “Send As” e-mail address domain.

Apparently, there is a clear need for a convenient, reliable and effective manner of protecting e-mail identity. Embodiments of the present invention provide a novel system and method for protecting users' actual e-mail identities from being exposed on the Internet.

### SUMMARY

The present invention is a system and method for protecting the identity of an e-mail sender via use of customized recipient e-mail addresses. The system and method comprise the steps of:

A registered user of an e-mail forwarding server of the present invention sends an e-mail message to a customized recipient's e-mail address. Because the e-mail forwarding server is the Mail Exchange (MX) authority for the domain of the customized recipient e-mail address, the message is sent to the e-mail forwarding server. The e-mail forwarding server contains a database including user's actual e-mail addresses and their associated alias e-mail addresses. Once the e-mail forwarding server receives the message, it first extracts the intended recipient's e-mail address from the message, then replaces message sender's e-mail address with its associated alias e-mail address, and delivers the message to the original intended recipient. To the recipient the message seems to be sent from the e-mail forwarding server directly and the sender's e-mail address is user's alias e-mail address. Hence the user's actual e-mail identity is not exposed to the recipient. When the e-mail forwarding server receives an e-mail message sent to the user's alias e-mail address, it automatically forwards the message to the user's registered actual e-mail address stored in the database.

The present invention also provides various techniques of customizing recipient e-mail address, which allow users easily choose one of their alias e-mail addresses, or use system generated random alias e-mail addresses, or schedule message delivery.

The present invention provides advantages in that protecting people's actual e-mail identity from being exposed on the Internet, which can be used with any e-mail clients or devices. It does not require any software installation or switching between different e-mail accounts.

### BRIEF DESCRIPTION OF THE DRAWINGS

FIG. 1 is a block diagram depicting a network system in which a preferred embodiment of the invention may be practiced.

FIG. 2 is a look-up table used by the present invention.

FIG. 3 is a diagram illustrating an exemplary embodiment of e-mail message forwarding process in accordance with the present invention.

FIGS. 4A, 4B and 4C are diagrams illustrating exemplary embodiments of customizing recipient's e-mail addresses in accordance with the present invention.

FIG. 5 is a diagram illustrating an exemplary embodiment of e-mail message forwarding process in accordance with the present invention.

FIGS. 6A and 6B present a flow chart showing detail of steps of processing message envelope addresses and headers in an e-mail forwarding server.

FIG. 7 is a diagram showing a mail flow of sending and receiving e-mail messages in accordance with an embodiment of the present invention.

FIG. 8 is a diagram illustrating another exemplary embodiment of e-mail message forwarding process in accordance with the present invention.

FIG. 9 is a diagram illustrating another exemplary embodiment of e-mail message forwarding process in accordance with the present invention.

FIG. 10 is a diagram illustrating yet another exemplary embodiment of e-mail message forwarding process in accordance with the present invention.

FIG. 11 is a diagram illustrating an exemplary embodiment of selecting alias e-mail address in accordance with the present invention.

FIG. 12 is another look-up table used by the present invention.

FIG. 13 is a diagram illustrating an exemplary embodiment of using system generated random alias e-mail address in accordance with the present invention.

FIG. 14 is a diagram illustrating an exemplary embodiment of scheduling e-mail message delivery in accordance with the present invention.

FIG. 15 is a diagram illustrating an exemplary embodiment of using multiple predetermined delimited characters and parameters in accordance with the present invention.

FIG. 16 is a diagram illustrating another exemplary embodiment of using multiple predetermined delimited characters and parameters in accordance with the present invention.

### DETAILED DESCRIPTION OF THE PREFERRED EMBODIMENTS

In the following description, the different embodiments of the invention are explained from the point of view of showing how a user redirects e-mail messages to an e-mail forwarding server via use of customized recipient e-mail addresses and how an e-mail forwarding server protects the user's actual e-mail identity.

### Preferred Environment

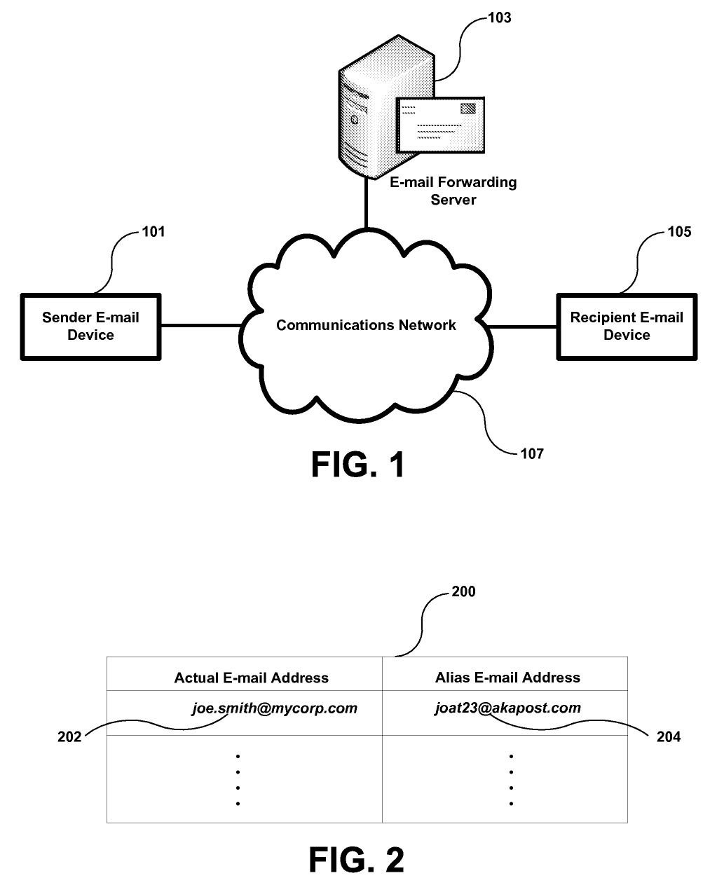

FIG. 1 is a block diagram of a network system for practicing the preferred embodiments of the present invention. The system includes a device 101 for sending and receiving e-mail messages, an e-mail forwarding server 103, a device 105 for sending and receiving e-mail messages, and a network communications mechanism 107.

The device 101 can be any device, which is capable of generating and transmitting e-mail messages (e.g., pager, mobile phone, PDA, Blackberry, and PC, etc.).

The e-mail forwarding server 103 is provided with software programmed to perform the below described steps necessary to operate the present invention. As shown in FIG. 2, the software program in e-mail forwarding server 103 includes a look-up table 200, which is programmable to provide a subscriber's actual e-mail address 202 associated with a pre-programmed subscriber's alias e-mail address 204. The look-up table 200 may include a plurality of alias e-mail addresses (204+N), with each alias e-mail address being associated with one or more subscriber's actual e-mail addresses (202+M).

The device 105 can be any device, which is capable of generating and transmitting e-mail messages (e.g., pager, mobile phone, PDA, Blackberry, and PC).

The network communications mechanism 107 provides a mechanism for facilitating communication between device 101, e-mail forwarding server 103, and device 105. As is well known, the Internet provides network communication lines between device 101, e-mail forwarding server 103, and device 105 through Internet Service Providers (ISP).

It is to be appreciated that in this description of the present invention e-mail forwarding server 103, mention is made to both a “user” and “subscriber” of e-mail forwarding server 103. It is to be understood that a “user” of e-mail forwarding server 103 refers to anyone who is capable of transmitting e-mail messages and accessing e-mail forwarding server 103 when it is desired to use an alias e-mail address as the sender's e-mail address to transmit messages to a recipient.

A “subscriber” of e-mail forwarding server 103 refers to anyone who subscribes to the e-mail forwarding service of server 103 in which the subscriber registers both at least one alias e-mail address 204 and at least one actual e-mail address 202 in e-mail forwarding server 103.

A subscriber or user may also be referred to as a “sender” or “recipient” of an e-mail using the present invention. E-mail forwarding server 103 is accessible by any user.

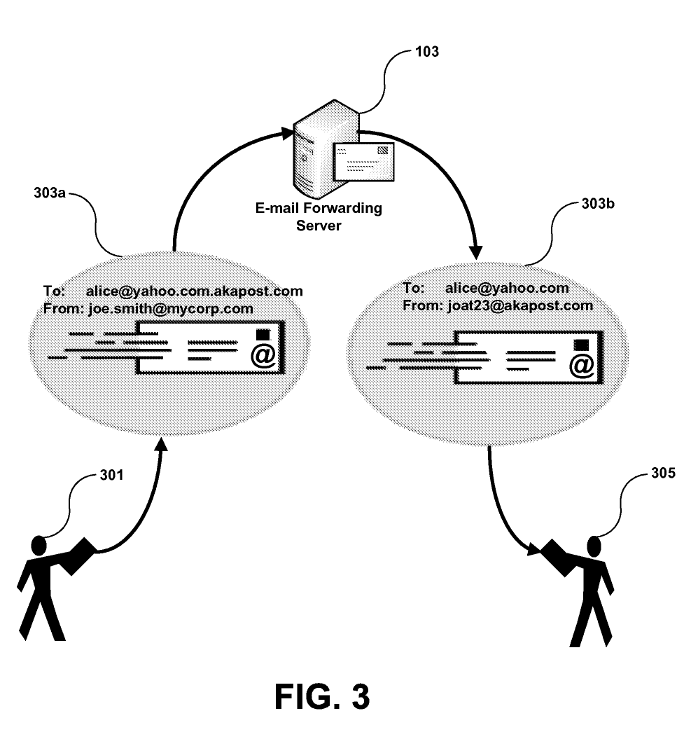

In accordance with the present invention as shown in FIG. 3, Sender 301 is a subscriber of e-mail forwarding server 103. Sender 301 also has another e-mail account with an actual e-mail address (e.g., joe.smith@mycorp.com) in a different e-mail system. Sender 301 desires to send an e-mail message directly from his/her actual e-mail account to recipient 305 (e.g., alice@yahoo.com), but doesn't want to let recipient 305 know his/her actual e-mail address (e.g., joe.smith@mycorp.com).

In a preferred embodiment, first sender 301 accesses a designated account in e-mail forwarding server 103 via any known means such as the Internet, and registers an actual e-mail address (e.g., joe.smith@mycorp.com) and its associated alias e-mail address (e.g., joat23@akapost.com) in e-mail forwarding server 103. Second sender 301 uses his/her actual e-mail account to compose an e-mail message 303a, and follows the “Customizing E-Mail Address” method described below to create a customized recipient's e-mail address (e.g., alice@yahoo.com.akapost.com). Next sender 301 sends the message to this customized recipient's e-mail address.

### Customizing E-Mail Address

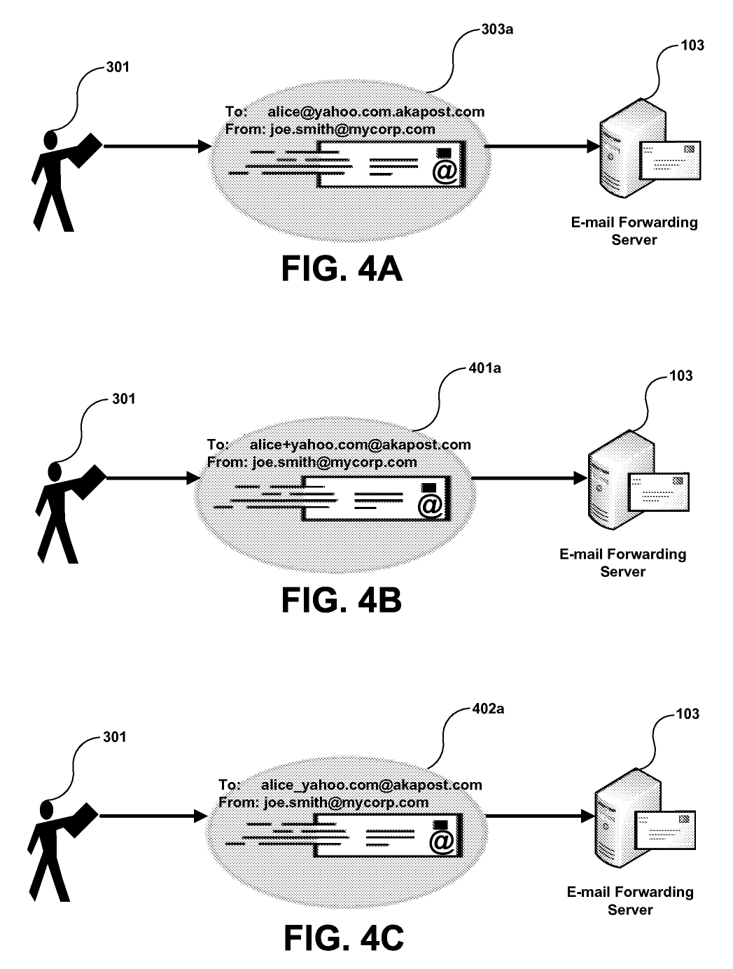

If the domain name (e.g., yahoo.com) of a recipient's e-mail address (e.g., alice@yahoo.com) is not the same as an e-mail forwarding server's authoritative e-mail domain name (e.g., akapost.com), an e-mail sender needs to customize the recipient's e-mail address to redirect the message to the e-mail forwarding server. The method of customizing e-mail address is now described below with reference to FIGS. 4A, 4B and 4C.

In a preferred embodiment as shown in FIG. 4A, sender 301 appends a domain name extension string “.akapost.com” to recipient's e-mail address (e.g., alice@yahoo.com) to generate a customized recipient's e-mail address (e.g., alice@yahoo.com.akapost.com) and sends message 303a to this customized recipient's e-mail address. Since e-mail forwarding server 103 is the Mail Exchange (MX) authority for “akapost.com” domain, so message 303a is delivered to e-mail forwarding server 103.

In alternative embodiments as shown in FIGS. 4B and 4C, sender 301 replaces “@” character in recipient's e-mail address (e.g., alice@yahoo.com) with a “+” (plus) or “_”(underscore) character to generate a new string (e.g., alice+yahoo.com or alice_yahoo.com), then appends a domain name extension “@akapost.com” to this new string to create a new e-mail address (e.g., alice+yahoo.com@akapost.com or alice_yahoo.com@akapost.com), then sends message 401a or 402a to this new customized recipient's e-mail address. These methods also redirect message 401a or 402a to e-mail forwarding server 103.

In the following, embodiments of the present invention are based on the first preferred “Customizing E-Mail Address” embodiment as shown in FIG. 4A but may be modified to suit another “Customizing E-Mail Address” embodiment, such as the embodiment described above with reference to FIGS. 4B or 4C, to produce substantially the same results.

### Forwarding E-mail Message

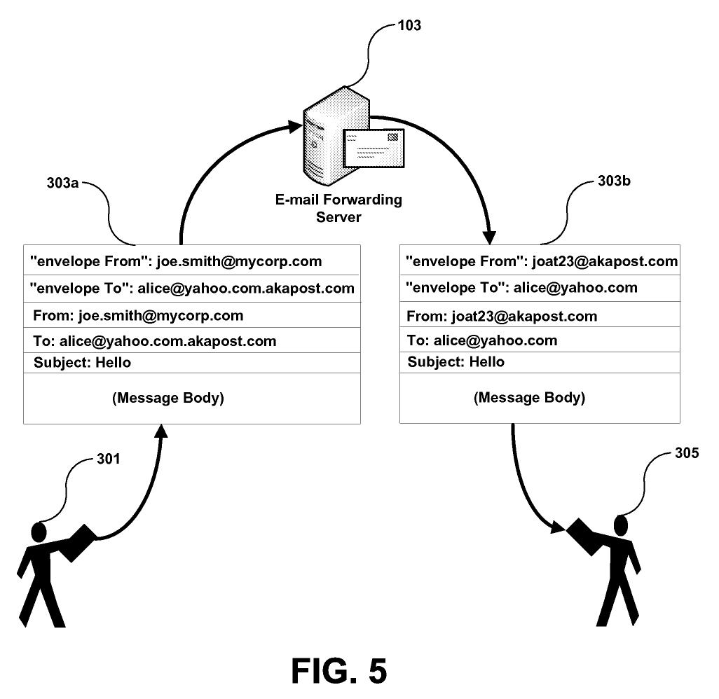

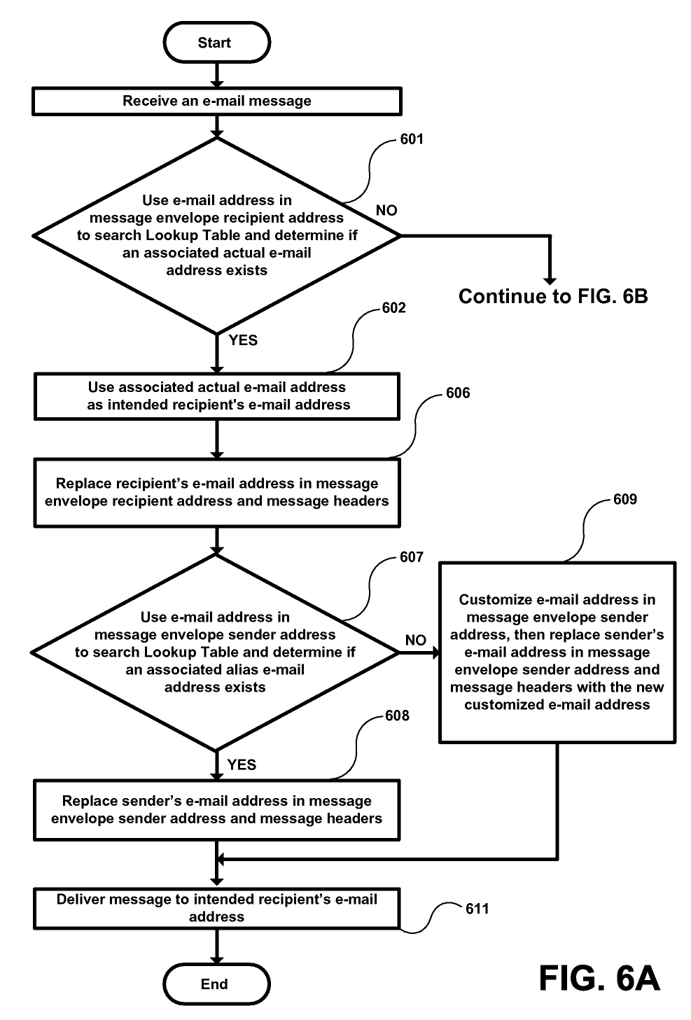

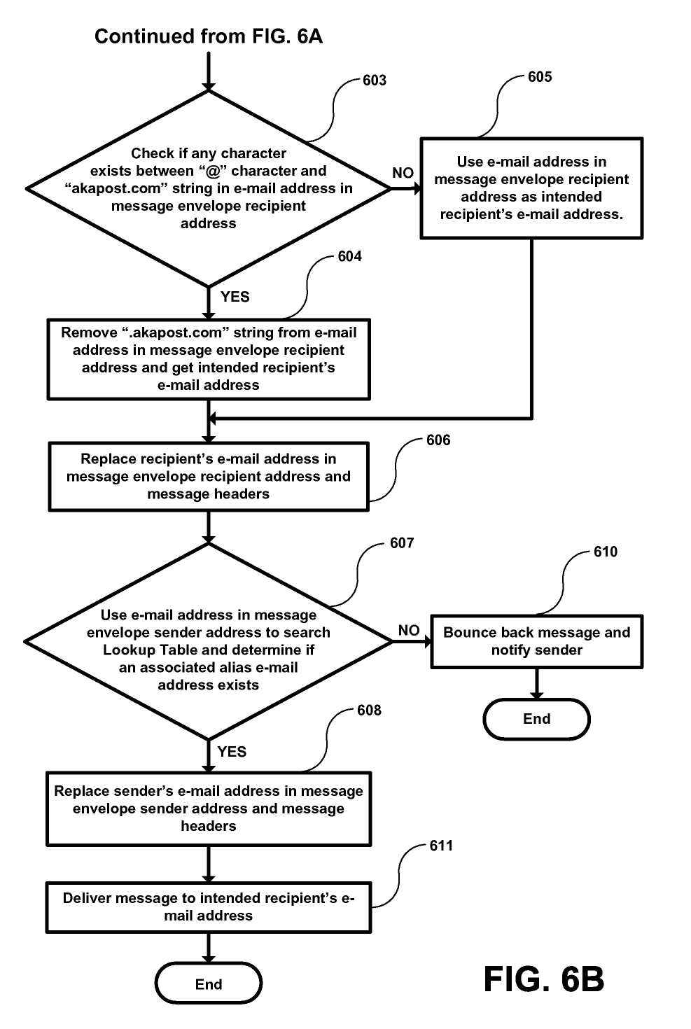

In a preferred embodiment as shown in FIG. 5, after e-mail forwarding server 103 receives message 303a sent to the customized recipient's e-mail address (e.g., alice@yahoo.com.akapost.com) from sender 301 (e.g., joe.smith@mycorp.com), it starts processing message 303a's envelope addresses and message headers, and generates a re-addressed message 303b, then delivers message 303b to the intended recipient 305's e-mail address (e.g., alice@yahoo.com). The detail steps are described below as shown in FIGS. 6A and 6B:

Step 601:
E-mail forwarding server 103 uses the envelope recipient address (e.g., alice@yahoo.com.akapost.com) of the message to search lookup table 200 and determine if an associated actual e-mail address exists.

Step 602:
If e-mail forwarding server 103 does find the associated actual e-mail address in “Step 601”, it uses this associated actual e-mail address as the intended recipient's e-mail address and skips “Step 603”, “Step 604” and “Step 605”.

Step 603:
If e-mail forwarding server 103 does not find the associated actual e-mail address in “Step 601”, it checks if any character exists between “@” character and “akapost.com” string in the envelope recipient address (e.g., alice@yahoo.com.akapost.com) of the message.

Step 604:
If the result of “Step 603” is true, e-mail forwarding server 103 obtains the intended recipient's e-mail address (e.g., alice@yahoo.com) by removing “.akapost.com” string in the envelope recipient address (e.g., alice@yahoo.com.akapost.com) of the message.

Step 605:
If the result of “Step 603” is false, e-mail forwarding server 103 uses the envelope recipient address of the message as the intended recipient's e-mail address.

Step 606:
After e-mail forwarding server 103 obtains the intended recipient's e-mail address in “Step 602” or “Step 604” or “Step 605”, it substitutes all occurrences of the existing recipient e-mail address (e.g., alice@yahoo.com.akapost.com) in the envelope recipient address and message headers with the intended recipient's e-mail address (e.g., alice@yahoo.com).

Step 607:
Then e-mail forwarding server 103 uses the envelope sender address (e.g., joe.smith@mycorp.com) of the message to search lookup table 200 and determine if an associated alias e-mail address (e.g., joat23@akapost.com) exists.

Step 608:
If e-mail forwarding server 103 does find the associated alias e-mail address (e.g., joat23@akapost.com) in the lookup table 200 in “Step 607”, it substitutes all occurrences of the existing sender e-mail address (e.g., joe.smith@mycorp.com) in the envelope sender address and message headers with the associated alias e-mail address (e.g., joat23@akapost.com).

Step 609:
If e-mail forwarding server 103 could not find the associated alias e-mail address in the lookup table 200 in “Step 607” and the result of “Step 601” is true (as shown in FIG. 6A), it follows the methods described in the “Customizing E-Mail Address” section to customize the e-mail address in the envelope sender address and creates a customized sender's e-mail address, then substitutes all occurrences of the existing sender e-mail address in the envelope sender address and message headers with this new customized sender's e-mail address.

Step 610:
If e-mail forwarding server 103 could not find the associated alias e-mail address in the lookup table in “Step 607” and the result of “Step 601” is false (as shown in FIG. 6B), it bounces back the e-mail message, and notifies the sender that the sender's actual e-mail address has not been registered in e-mail forwarding server 103 and users need to register first before they can use this e-mail forwarding service. E-mail forwarding server 103 stops further processing of this message.

Step 611:
After e-mail forwarding server 103 replaces the recipient and sender e-mail addresses in the envelope addresses and message headers, it delivers this re-addressed message to the intended recipient's e-mail address (e.g., alice@yahoo.com).

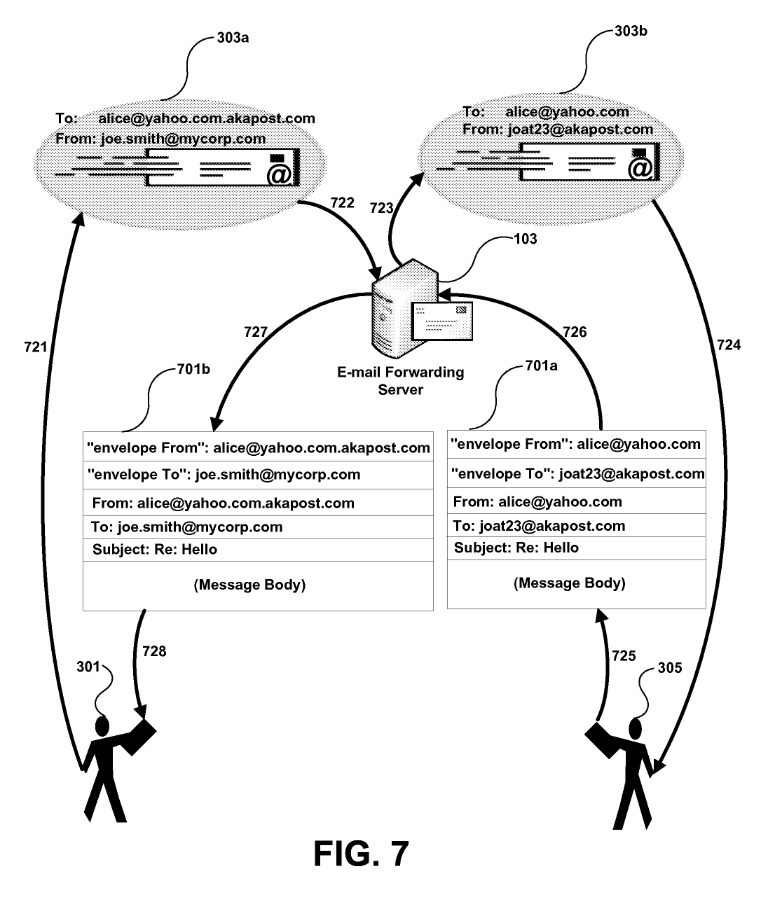

In a preferred embodiment as shown in FIG. 7 (Mail flow direction is from 721 to 728), when recipient 305 receives message 303b, recipient 305 doesn't know sender 301's actual e-mail address (e.g., joe.smith@mycorp.com) because the original sender's e-mail address has been replaced with the sender's alias e-mail address (e.g., joat23@akapost.com). To recipient 305 message 303b seems to be sent directly from sender 301's alias e-mail address (e.g., joat23@akapost.com). When recipient 305 sends a reply message 701a to 301, message 701a is sent to 301's alias e-mail address (e.g., joat23@akapost.com).

After e-mail forwarding server 103 receives message 701a from 305, it follows steps from “Step 601” to “Step 611” (as shown in FIGS. 6A and 6B) to process message 701a's envelope addresses and message headers, and generate a re-addressed message 701b, then deliver message 701b to the intended recipient's e-mail address. Because the result of “Step 602” (as shown in FIG. 6A) is true in this example, so the intended recipient's e-mail address is 301's actual e-mail address (e.g., joe.smith@mycorp.com). Therefore 301's actual e-mail account receives this reply message sent from 305.

As described above, once users registered their actual e-mail addresses and alias e-mail addresses in the e-mail forwarding server of this invention, the users are able to send or receive e-mail messages directly through their registered actual e-mail accounts without exposing their actual e-mail addresses to recipients.

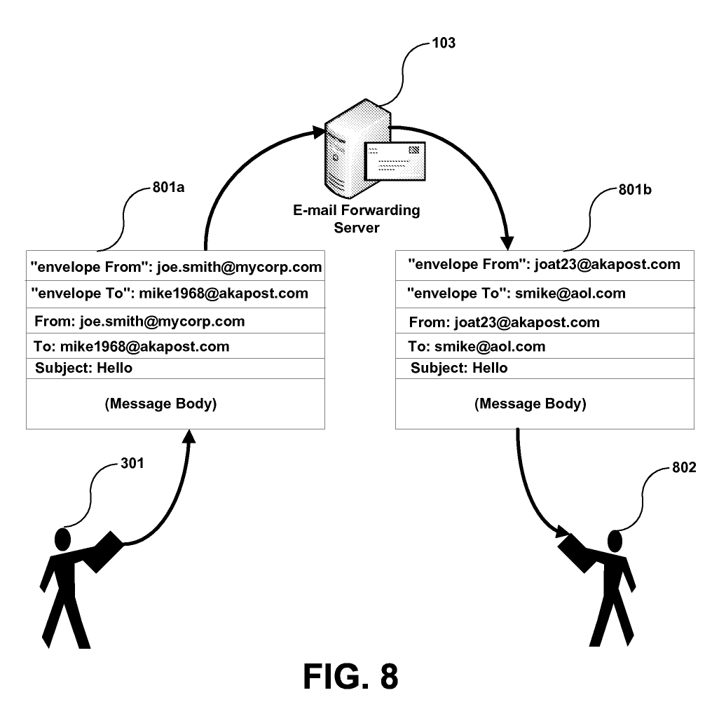

FIG. 8 illustrates another example of forwarding e-mail message according to an embodiment of the present invention. As shown in FIG. 8, a subscribed sender 301 sends an e-mail message 801a to a subscribed recipient 802's e-mail address (e.g., mike1968@akapost.com). Since the domain name (e.g., akapost.com) of recipient 802's e-mail address (e.g., mike1968@akapost.com) is the same as e-mail forwarding server 103's authoritative e-mail domain name (e.g., akapost.com), sender 301 doesn't need to customize recipient 802's e-mail address (e.g., mike1968@akapost.com). Sender 301 sends message 801a directly to recipient 802's e-mail address (e.g., mike1968@akapost.com).

After e-mail forwarding server 103 receives message 801a, it follows steps from “Step 601” to “Step 611” (as shown in FIGS. 6A and 6B) to process message 801a's envelope addresses and message headers, and generate a re-addressed message 801b, then deliver message 801b to recipient 802's registered actual e-mail address (e.g., smike@aol.com).

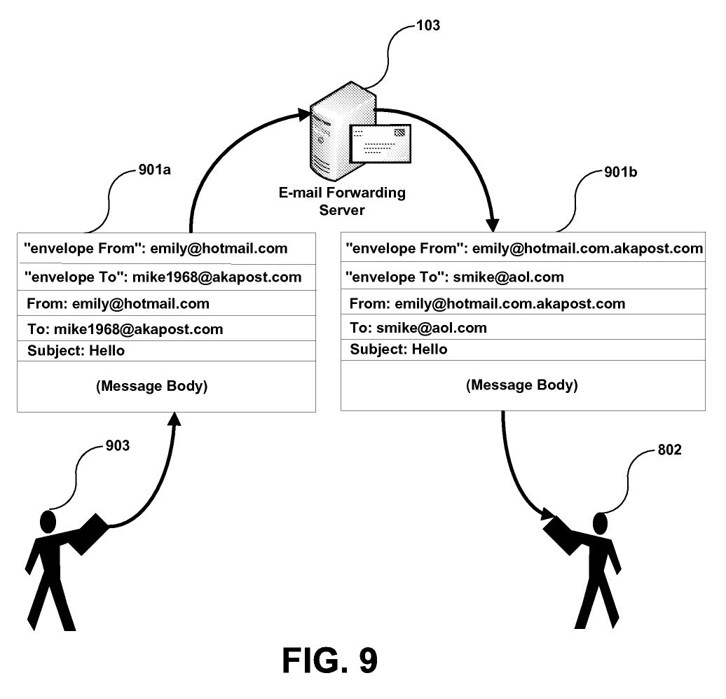

FIG. 9 illustrates another example of forwarding e-mail message according to an embodiment of the present invention. As shown in FIG. 9, a non-subscribed sender 903 (e.g., emily@hotmail.com) sends an e-mail message 901a to a subscribed recipient 802's e-mail address (e.g., mike1968@akapost.com). Since sender 903 is not a subscriber of e-mail forwarding server 103, sender 903 will not modify recipient 802's e-mail address. Sender 903 sends message 901a directly to recipient 802's e-mail address (e.g., mike1968@akapost.com). The message is delivered to e-mail forwarding server 103.

After e-mail forwarding server 103 receives message 901a, it follows steps from “Step 601” to “Step 611” (as shown in FIGS. 6A and 6B) to process message 901a's envelope addresses and message headers, and generate a re-addressed message 901b, then deliver message 901b to recipient 802's registered actual e-mail address (e.g., smike@aol.com).

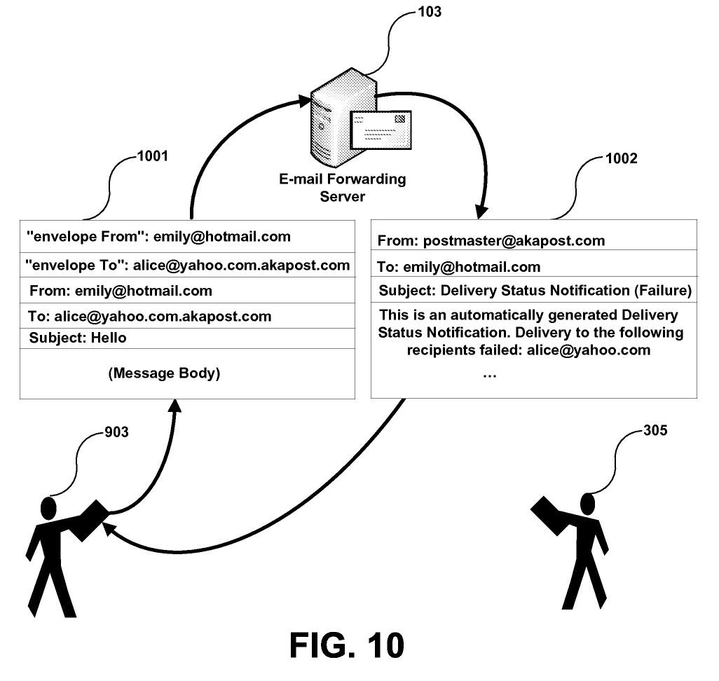

FIG. 10 illustrates another example of forwarding e-mail message according to an embodiment of the present invention. As shown in FIG. 10, a non-subscribed sender 903 (e.g., emily@hotmail.com) sends an e-mail message 1001 to a non-subscribed recipient 305's e-mail address (e.g., alice@yahoo.com). Since sender 903 is not a subscriber of e-mail forwarding server 103, sender 903 should not modify any recipient's e-mail address. But for some reasons if sender 903 wants to use the e-mail forwarding service of the present invention and follows the methods described in the “Customizing E-Mail Address” section to create a customized e-mail address (e.g., alice@yahoo.com.akapost.com), and sends message 1001 to this customized e-mail address (e.g., alice@yahoo.com.akapost.com). As a result, the message is sent to e-mail forwarding server 103.

After e-mail forwarding server 103 receives message 1001, it follows steps from “Step 601” to “Step 611” (as shown in FIGS. 6A and 6B) to process message 1001's envelope addresses and message headers. Since sender 903 is not a registered user and recipient 305's customized e-mail address (e.g., alice@yahoo.com.akapost.com) doesn't have an associated alias e-mail address, e-mail forwarding server 103 bounces back message 1001, and notifies sender 903 with message 1002 that sender 903's e-mail address has not been registered in e-mail forwarding server 103 and users need to register first before they can use this e-mail forwarding service.

In accordance with the present invention, as will be discussed further below the subscriber can also use various customizing recipient e-mail address methods to easily select different alias e-mail addresses, or use system generated random alias e-mail addresses, or schedule message delivery.

### Selecting Alias E-Mail Address

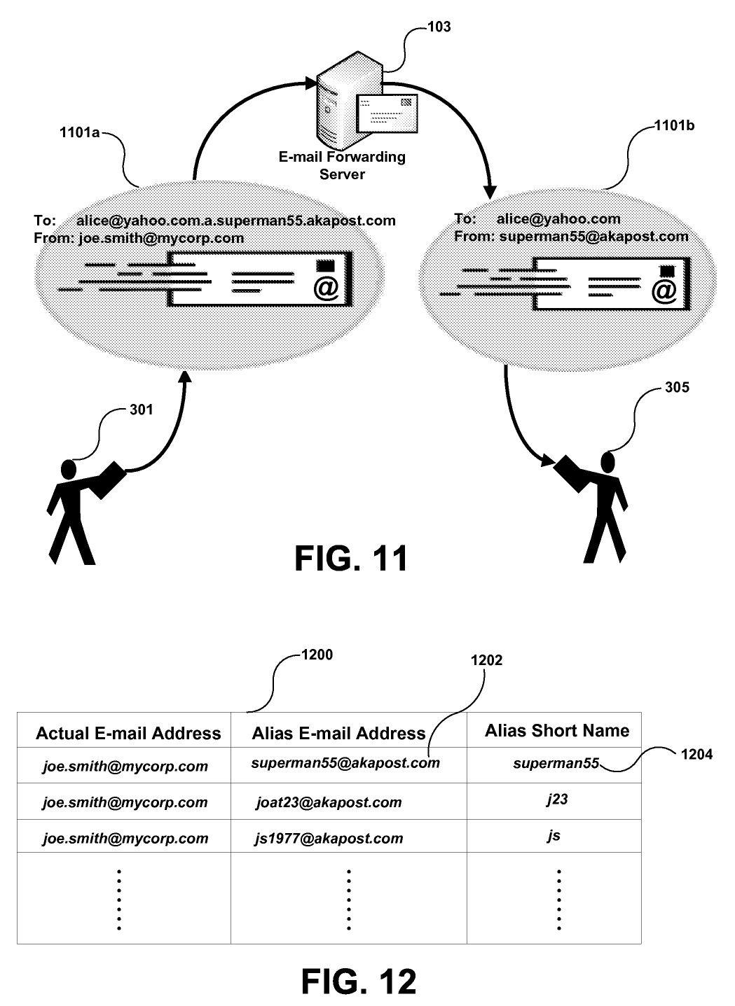

In another embodiment of the present invention, a user may have multiple alias e-mail addresses registered in an e-mail forwarding server and the user can a specific predetermined delimited character and corresponding parameter to select one of alias e-mail addresses to send e-mail messages. As shown in FIG. 11, sender 301 registered multiple alias e-mail addresses and their associated alias short names (as shown in FIG. 12) in e-mail forwarding server 103. If sender 301 desires to use one of alias e-mail addresses (e.g., superman55@akapost.com) to send an e-mail message to recipient 305 (e.g., alice@yahoo.com), sender 301 first uses the methods described in the “Customizing E-Mail Address” section to create a customized recipient's e-mail address (e.g., alice@yahoo.com.akapost.com), next adds a specific predetermined delimited character (e.g., a) and a pre-registered alias short name (e.g., superman55) into the customized recipient's e-mail address to generate a new customized recipient's e-mail address (e.g., alice@yahoo.com.a.superman55.akapost.com), then sends e-mail message 1101a to this e-mail address.

The “a” character in this new customized recipient's e-mail address (e.g., alice@yahoo.com.a.superman55.akapost.com) is an example of the predetermined delimited character. The e-mail forwarding server can use it to identify and extract the alias short name (e.g., superman55) from the customized recipient's e-mail address (e.g., alice@yahoo.com.a.superman55.akapost.com). The alias short name is used for the e-mail forwarding server to select a different alias e-mail address. In the e-mail forwarding server every alias short name is associated with an alias e-mail address (as shown in FIG. 12). By default the alias short name is same as the local part of its associated alias e-mail address (e.g., superman55).

After e-mail forwarding server 103 receives message 1101a, it first uses the predetermined delimited character (e.g., a) in the envelope recipient address (e.g., alice@yahoo.com.a.superman55.akapost.com) to identify and extract alias short name 1204 (e.g., superman55), second obtains the intended recipient's e-mail address (e.g., alice@yahoo.com) by removing all predetermined delimited character and parameter and “.akapost.com” string (e.g., .a.superman55.akapost.com) in the envelope recipient address (e.g., alice@yahoo.com.a.superman55.akapost.com), and substitutes all occurrences of the existing recipient e-mail address in the envelope recipient address and message headers with the intended recipient's e-mail address (e.g., alice@yahoo.com), third uses the extracted alias short name 1204 (e.g., superman55) and the envelope sender address (e.g., joe.smith@mycorp.com) to search lookup table 1200 (as shown in FIG. 12) and obtains associated alias e-mail address 1202 (e.g., superman55@akapost.com), and substitutes all occurrences of the existing sender e-mail address in the envelope sender address and message headers with alias e-mail address 1202 (e.g., superman55@akapost.com), then delivers this re-addressed message 1101b to recipient 305.

This process is similar with the process described in the steps from “Step 601” to “Step 611” in the “Forwarding E-mail Message” section, except using more sophisticated methods to extract alias short name and intended recipient's e-mail address, and using a different alias e-mail address.

If sender 301 desires to use another alias e-mail address (e.g., js1977@akapost.com) to send an e-mail message to recipient 305, sender 301 can use the same methods described above to create a new customized recipient's e-mail address (e.g., alice@yahoo.com.a.js.akapost.com) and submit the e-mail message to this e-mail address.

E-mail forwarding server 103 can define one of alias e-mail addresses as a user's default alias e-mail address (e.g., joat23@akapost.com). Therefore when the user sends an e-mail message without using any predetermined delimited character, e-mail forwarding server 103 will automatically select the default alias e-mail address (e.g., joat23@akapost.com) to deliver the message.

The specific predetermined delimited character and corresponding parameter can be any other valid Internet host name character(s) (e.g., letters, numbers, or hyphens). But they have to be completely defined before launching the e-mail forwarding service of the present invention. The e-mail forwarding service also needs to provide a user guide explains how to use this specific predetermined delimited character and corresponding parameter.

### Using System Generated Random Alias E-mail Address

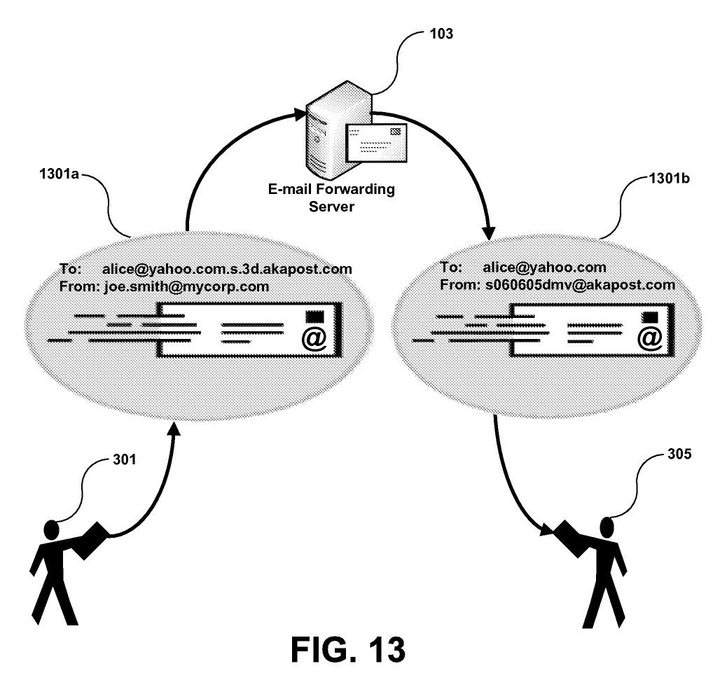

In another embodiment of the present invention, a user can use a specific predetermined delimited character and corresponding parameter to choose using system generated random alias e-mail addresses to send e-mail messages. As shown in FIG. 13, if sender 301 desires to deliver an e-mail message to recipient 305 (e.g., alice@yahoo.com) using a system generated random alias e-mail address, sender 301 first uses the methods described in the “Customizing E-Mail Address” section to create a customized recipient's e-mail address (e.g., alice@yahoo.com.akapost.com), next adds a predetermined delimited character (e.g., s) and a lifespan parameter (e.g., 3 d) into the customized recipient's e-mail address to generate a new customized recipient's e-mail address (e.g., alice@yahoo.com.s.3d.akapost.com), then sends e-mail message 1301a to this e-mail address.

The “s” character in this new customized recipient's e-mail address (e.g., alice@yahoo.com.s.3d.akapost.com) is an example of the predetermined delimited characters. The e-mail forwarding server can use it to identify and extract the lifespan parameter (e.g., 3 d) from the customized recipient's e-mail address (e.g., alice@yahoo.com.s.3d.akapost.com). The lifespan parameters are specified by using suffixes “y”, “m”, and “d”. The “3d” means three days.

After e-mail forwarding server 103 receives message 1301a, it first uses a predetermined delimited character (e.g., s) in the envelope recipient address (e.g., alice@yahoo.com.s.3d.akapost.com) to identify and extract lifespan information (e.g., 3 d), second obtains the intended recipient's e-mail address (e.g., alice@yahoo.com) by removing all predetermined delimited character and parameter and “.akapost.com” string (e.g., .s.3d.akapost.com) in the envelope recipient address (e.g., alice@yahoo.com.s.3d.akapost.com), and substitutes all occurrences of the existing recipient e-mail address in the envelope recipient address and message headers with the intended recipient's e-mail address (e.g., alice@yahoo.com), third generates a random alias e-mail address (e.g., s060605dmv@akapost.com), and substitutes all occurrences of the existing sender e-mail address in the envelope sender address and message headers with this system generated random alias e-mail address (e.g., s060605dmv@akapost.com), then delivers this re-addressed message 1301b to recipient 305.

This process is similar with the process described in the steps from “Step 601” to “Step 611” in the “Forwarding E-mail Message” section, except using more sophisticated methods to extract lifespan information, and using a system generated random alias e-mail address. Since the lifespan for this system generated random alias e-mail address (e.g., s060605dmv@akapost.com) is three days, so this alias e-mail address (e.g., s060605dmv@akapost.com) will be valid for 3 days only. After 3 days, this system generated random alias e-mail address (e.g., s060605dmv@akapost.com) will not accept any e-mail messages.

The specific predetermined delimited character and corresponding parameter mentioned above can be any other valid Internet host name character(s) (e.g., letters, numbers, or hyphens). But they have to be completely defined before launching the e-mail forwarding service of the present invention. The e-mail forwarding service also needs to provide a user guide explains how to use this specific predetermined delimited character and corresponding parameter.

### Scheduling E-Mail Message Delivery

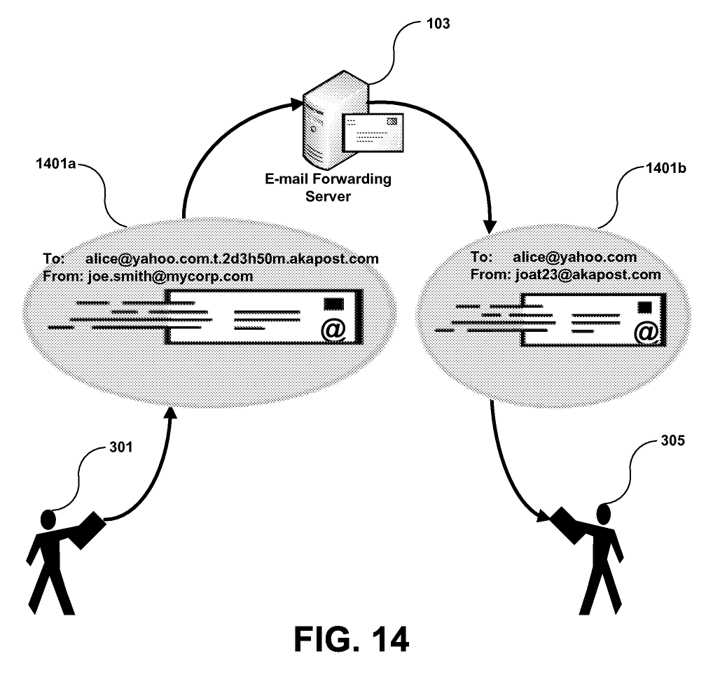

In another embodiment of the present invention, a user can use a specific predetermined delimited character and corresponding parameter to schedule date and time to deliver e-mail messages. As shown in FIG. 14, if sender 301 desires to deliver an e-mail message to recipient 305 (e.g., alice@yahoo.com) 2 days 3 hours and 50 minutes later, sender 301 first uses the methods described in the “Customizing E-Mail Address” section to create a customized recipient's e-mail address (e.g., alice@yahoo.com.akapost.com), next adds a predetermined delimited character (e.g., t) and a delivery data/time parameter (e.g., 2d3h50m) into the customized recipient's e-mail address to generate a new customized recipient's e-mail address (e.g., alice@yahoo.com.t.2d3h50m.akapost.com), then sends e-mail message 1401a to this e-mail address.

The “t” character in this new customized recipient's e-mail address (e.g., alice@yahoo.com.t.2d3h50m.akapost.com) is an example of the predetermined delimited characters. The e-mail forwarding server can use it to identify and extract the delivery data/time parameter (e.g., 2d3h50m) from the customized recipient's e-mail address (e.g., alice@yahoo.com.t.2d3h50m.akapost.com). The delivery data/time intervals are specified by using suffixes “d”, “h”, and “m”. The “2d3h50m” means 2 days, 3 hours, and 50 minutes.

After e-mail forwarding server 103 receives message 1401a, it first uses a predetermined delimited character (e.g., t) in the envelope recipient address (e.g., alice@yahoo.com.t.2d3h50m.akapost.com) to identify and extract delivery data/time information (e.g., 2d3h50m), second obtains the intended recipient's e-mail address (e.g., alice@yahoo.com) by removing all predetermined delimited character and parameter and “.akapost.com” string (e.g., .t.2d3h50m.akapost.com) in the envelope recipient address (e.g., alice@yahoo.com.t.2d3h50m.akapost.com), and substitutes all occurrences of the existing recipient e-mail address in the envelope recipient address and message headers with the intended recipient's e-mail address (e.g., alice@yahoo.com), third uses the envelope sender address (e.g., joe.smith@mycorp.com) to search lookup table 200 (as shown in FIG. 2) and obtains associated alias e-mail address 204 (e.g., joat23@akapost.com), and substitutes all occurrences of the existing sender e-mail address in the envelope sender address and message headers with alias e-mail address 204 (e.g., joat23@akapost.com), then delivers this re-addressed message 1401b to recipient 305 after 2 days, 3 hours, and 50 minutes.

This process is similar with the process described in the steps from “Step 601” to “Step 611” in the “Forwarding E-mail Message” section, except using more sophisticated methods to extract delivery data/time information and intended recipient's e-mail address, and delivering messages at a scheduled date/time.

The specific predetermined delimited character and corresponding parameter mentioned above can be any other valid Internet host name character(s) (e.g., letters, numbers, or hyphens). But they have to be completely defined before launching the e-mail forwarding service of the present invention. The e-mail forwarding service also needs to provide a user guide explains how to use this specific predetermined delimited character and corresponding parameter.

### Using Multiple Parameters

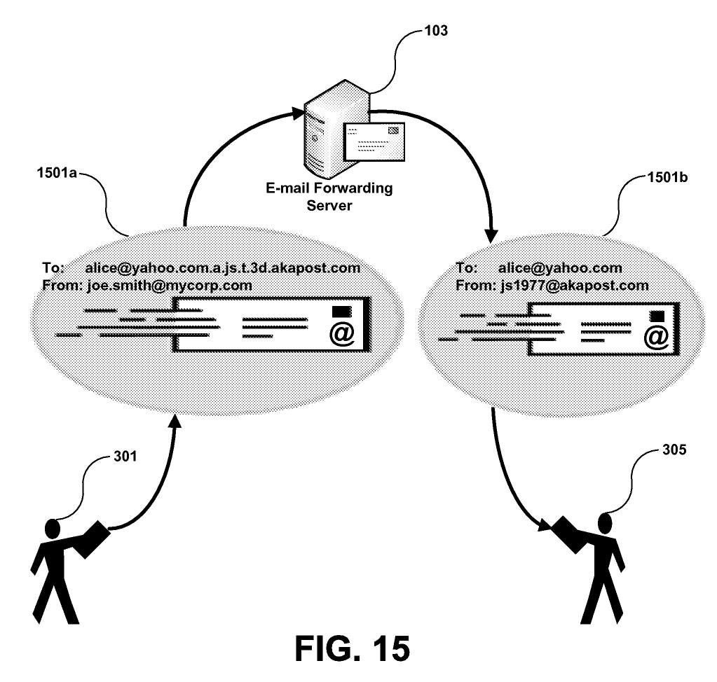

In another embodiment of the present invention, a user can mix some predetermined delimited characters and parameters mentioned above to meet some special requests. As shown in FIG. 15, if sender 301 desires to use one of alias e-mail addresses (e.g., js1977@akapost.com) to deliver an e-mail message to recipient 305 (e.g., alice@yahoo.com) 3 days later, sender 301 adds multiple predetermined delimited characters (e.g., a, t) and parameters (e.g., js, 2d3h50m) into the customized recipient's e-mail address (e.g., alice@yahoo.com.akapost.com) created by using the methods described in the “Customizing E-Mail Address” section to generate a new customized recipient's e-mail address (e.g., alice@yahoo.com.a.js.t.3d.akapost.com), and sends e-mail message 1501a to this e-mail address.

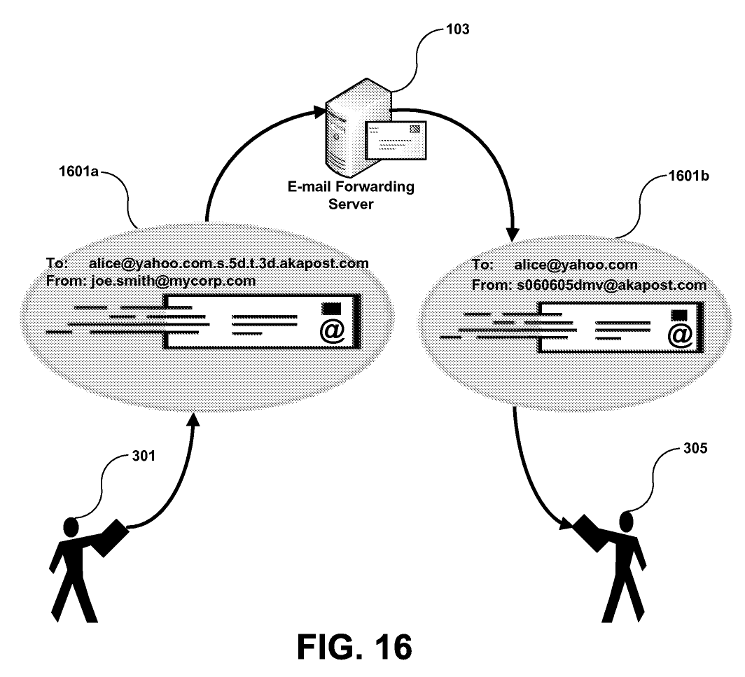

As another example of using multiple predetermined delimited characters and parameters according to an embodiment of the present invention shown in FIG. 16, if sender 301 desires to use a system generated random alias e-mail address (e.g., s060605dmv@akapost.com) to send an e-mail message to recipient 305 (e.g., alice@yahoo.com) 3 days later, sender 301 adds multiple predetermined delimited characters (e.g., s, t) and parameters (e.g., 5d, 3d) into the customized recipient's e-mail address (e.g., alice@yahoo.com.akapost.com) created by using the methods described in the “Customizing E-Mail Address” section to generate a new customized recipient's e-mail address (e.g., alice@yahoo.com.s.5d.t.3d.akapost.com), and sends e-mail message 1601a to this e-mail address.

After e-mail forwarding server 103 receives messages 1501a or 1601a, it follows the same procedures described above in the “Selecting Alias E-mail Address”, “Using System Generated Random Alias E-mail Address” and “Scheduling E-mail Message Delivery” sections to process message 1501a or 1601a, and delivers the messages in the way sender 301 intended.

These specific predetermined delimited characters and corresponding parameters mentioned above can be any other valid Internet host name characters (e.g., letters, numbers, or hyphens). But they have to be completely defined before launching the e-mail forwarding service of the present invention. The e-mail forwarding service also needs to provide a user guide explains how to use these specific predetermined delimited characters and corresponding parameters.

The present invention has been described in terms of a number of preferred embodiments. However, it will be understood by those of ordinary skill in the art that various modifications and improvements may be made to the invention as described, without departing from the spirit and scope of the invention.

What is claimed is:

1. A method for protecting actual e-mail sender identity from being exposed on a communications network via use of customized recipient e-mail addresses, the method comprising the steps of:
a) prescribing an alias e-mail address at an e-mail forwarding server by a user, the alias e-mail address is associated with a plurality of the user's actual e-mail addresses registered in the e-mail forwarding server;
b) creating in an outgoing e-mail message a customized recipient e-mail address designating the e-mail forwarding server;
c) sending the outgoing e-mail message comprising the user's actual e-mail address as a sender address to the customized recipient e-mail address, so that the e-mail message is transmitted to the e-mail forwarding server;
d) receiving the e-mail message by the e-mail forwarding server;
e) obtaining an intended recipient's e-mail address from the recipient address of the e-mail message, then substituting all occurrences of the customized recipient e-mail address in the envelope recipient address and message headers of the e-mail message with the intended recipient's e-mail address;
f) obtaining the user's actual e-mail address from the sender address of the e-mail message, and determining whether an alias e-mail address presents in the e-mail forwarding server that corresponds with the user's actual e-mail address;
g) if an alias e-mail address presents that corresponds the user's actual e-mail address, then substituting all occurrences of the user's actual e-mail address in the envelope sender address and message headers of the e-mail message with the alias e-mail address, and transmitting the e-mail message to the intended recipient's e-mail address where the identity of the actual e-mail sender cannot be determined from the e-mail message, but it is possible to send or reply using the alias e-mail address, due to the fact that the e-mail forwarding server can retrieve the user's actual e-mail address that corresponds with the alias e-mail address, and then forward the e-mail message correctly.

2. The method of claim 1, further comprising prescribing at the e-mail forwarding server by the user two or more alias e-mail addresses, each of the alias e-mail addresses is associated with a plurality of different user's actual e-mail addresses.

3. The method of claim 1, wherein the customized recipient e-mail address includes a first and a second portion, wherein the first portion including a reference to the original intended recipient's e-mail address, which enables the e-mail forwarding server to restore the intended recipient's e-mail address to its original form, and wherein the second portion including an e-mail domain name of the e-mail forwarding server, which routes the e-mail message to the e-mail forwarding server.

4. The method of claim 1, further comprising creating in an outgoing e-mail message by the user two or more customized recipient e-mail addresses designating the e-mail forwarding server, and sending the e-mail message to two or more customized recipient e-mail addresses.

5. The method of claim 1, wherein the obtaining an intended recipient's e-mail address further comprising extracting the customized recipient e-mail address from the envelope recipient address of the e-mail message, removing the e-mail domain name of the e-mail forwarding server from the extracted e-mail address, and restoring the intended recipient e-mail address to its original form.

6. The method of claim 1, further comprising obtaining two or more intended recipients' e-mail addresses from the envelope recipient addresses of the e-mail message, then substituting all occurrences of each customized recipient e-mail address in the envelope recipient addresses and message headers of the e-mail message with its corresponding intended recipient's e-mail address.

7. The method of claim 6, wherein the obtaining two or more intended recipients' e-mail addresses further comprising extracting all customized recipient e-mail addresses from the envelope recipient addresses of the e-mail message, removing the e-mail domain name of the e-mail forwarding server from each of the extracted e-mail addresses, and restoring the intended recipient e-mail addresses to their original forms.

8. The method of claim 1, wherein the determining whether an alias e-mail address presents in the e-mail forwarding server further comprising searching the user's actual e-mail address and identifying the corresponding alias e-mail address in a lookup table.

9. The method of claim 8, wherein the lookup table stores user's actual e-mail addresses and corresponding alias e-mail addresses in the e-mail forwarding server.

10. The method of claim 1, wherein the customized recipient e-mail address further includes a plurality of predetermined delimited characters and corresponding parameters, which enable the e-mail forwarding server to transmit e-mail messages with various delivery options.

11. The method of claim 10, wherein the predetermined delimited characters and corresponding parameters are valid Internet host name characters, which are used to determine delivery options in the e-mail forwarding server.

12. The method of claim 10, wherein the various delivery options further comprise:
a) transmitting an e-mail message comprising a user-selected alias e-mail address as a sender address;
b) transmitting an e-mail message comprising a system generated random alias e-mail address as a sender address;
c) transmitting an e-mail message at a scheduled date and time;
d) transmitting an e-mail message comprising a user-selected alias e-mail address as a sender address at a scheduled date and time;
e) transmitting an e-mail message comprising a system generated random alias e-mail address as a sender address at a scheduled date and time.

13. The method of claim 12, wherein the user-selected alias e-mail address is one of the user's alias e-mail addresses, which is determined by using a specific predetermined delimited character and corresponding parameter in the customized recipient e-mail address, each corresponding parameter is associated with a user's alias e-mail address in the e-mail forwarding server.

14. The method of claim 12, wherein the system generated random alias e-mail address is used if a specific predetermined delimited character and corresponding parameter exists in a customized recipient e-mail address.

15. The method of claim 12, wherein the scheduled date and time is determined by a specific predetermined delimited character and corresponding parameter in a customized recipient e-mail address.
